(19) United States
(12) Patent Application Publication
(10) Pub. No.: US 2017/0335149 A1
(43) Pub. Date: Nov. 23, 2017

(54) PROCESSES FOR PRODUCING IN-LINE POLYOLEFIN BASED ADHESIVE COMPOSITIONS, AND ADHESIVE COMPOSITIONS AND FILMS THEREOF

(71) Applicant: Equistar Chemicals, LP, Houston, TX (US)

(72) Inventors: Maged G. Botros, Liberty Township, OH (US); Lindsay E. Corcoran, Liberty Township, OH (US); William R. Podborny, Cincinnati, OH (US)

(73) Assignee: Equistar Chemicals, LP, Houston, TX (US)

(21) Appl. No.: 15/593,568

(22) Filed: May 12, 2017

Related U.S. Application Data
(60) Provisional application No. 62/339,247, filed on May 20, 2016.

(51) Int. Cl. C09J 123/08; B32B 27/08; B32B 7/12

(52) U.S. Cl. CPC C09J 123/0815; B32B 7/12; B32B 27/08

(57) ABSTRACT

Adhesive compositions, processes of forming adhesive compositions, and multi-layer films are discussed herein. The processes generally include contacting an olefin monomer with a catalyst system within a polymerization zone to form an olefin based polymer under polymerization conditions sufficient to form the olefin based polymer, the catalyst system including a metal component generally represented by the formula:

MRₓ;

wherein M is a transition metal, R is a halogen, an alkoxy, or a hydrocarboxyl group and x is the valence of the transition metal, wherein the catalyst system further includes an internal donor (ID) comprising a C₃-C₆ cyclic ether; and withdrawing the olefin based polymer from the polymerization zone; and melt blending the olefin based polymer with a functionalized polyolefin to form a polyolefin based adhesive composition, wherein the process is an in-line process.

### CROSS-REFERENCE TO RELATED APPLICATIONS

This application is the Non-Provisional Patent Application, which claims benefit of priority to U.S. Provisional Application No. 62/339,247, filed May 20, 2016, the contents of which are incorporated herein by reference in their entirety.

### STATEMENT REGARDING FEDERALLY SPONSORED RESEARCH OR DEVELOPMENT

Not applicable.

### FIELD OF THE INVENTION

Embodiments of the present disclosure generally relate to polyolefin based adhesive compositions.

### BACKGROUND OF THE INVENTION

This section introduces information from the art that may be related to or provide context for some aspects of the techniques described herein and/or claimed below. This information is for background facilitating a better understanding of that which is disclosed herein. Such background may include a discussion of “related” art. That such art is related in no way implies that it is also “prior” art. The related art may or may not be prior art. The discussion is to be read in this light, and not as an admission of prior art.

Multi-layer films are widely used in a variety of applications, including packaging applications. Depending on the intended end-use application, the number and arrangement of layers and type of resin employed in each layer will vary.

One challenge experienced in the fabrication of multi-layer films is achieving sufficient bond strength between the various layers of the multi-layer film. In order to improve bonding between layers, a tie-layer may be disposed between one or more layers of the multi-layer film. However, even when multi-layer films include tie-layers, difficulties in adhering dissimilar layers can occur. Thus, it is desirable to develop adhesive compositions for use in tie-layers that are capable of sufficiently adhering dissimilar layers within a multi-layer film.

Contained herein are embodiments directed to resolving, or at least reducing, one or all of the problems mentioned above.

### SUMMARY OF THE INVENTION

Embodiments of the present disclosure include processes of forming adhesive compositions. The processes generally include contacting an olefin monomer with a catalyst system within a polymerization zone to form an olefin based polymer under polymerization conditions sufficient to form the olefin based polymer, the catalyst system including a metal component generally represented by the formula:

MRₓ;

wherein M is a transition metal, R is a halogen, an alkoxy, or a hydrocarboxyl group and x is the valence of the transition metal, wherein the catalyst system further includes an internal donor (ID) comprising a C₃-C₆ cyclic ether; and withdrawing the olefin based polymer from the polymerization zone; and melt blending the olefin based polymer with a functionalized polyolefin to form a polyolefin based adhesive composition, wherein the process is an in-line process.

One or more embodiments include the process of the preceding paragraph, wherein the olefin based polymer contacts the functionalized polyolefin prior to pelletization.

One or more embodiments include the process of any preceding paragraph and further include melt blending the olefin based polymer and the functionalized polyolefin in the presence of adhesion promoting additive.

One or more embodiments include the process of any preceding paragraph, wherein the transition metal is selected from titanium, chromium and vanadium.

One or more embodiments include the process of any preceding paragraph, wherein the metal component is selected from TiCl₄, TiBr₄, Ti(OC₂H₅)₃Cl, Ti(OC₃H₇)₂Cl₂, Ti(OC₆H₁₃)₂Cl₂, Ti(OC₂H₅)₂Br₂ and Ti(OC₁₂H₂₅)Cl₃.

One or more embodiments include the process of any preceding paragraph, wherein the catalyst system further includes an organoaluminum compound selected from trimethyl aluminum (TMA), triethyl aluminum (TEAl) and triisobutyl aluminum (TiBAl).

One or more embodiments include the process of any preceding paragraph, wherein the cyclic ethers are selected from tetrahydrofuran, dioxane, methyltetrahydrofuran and combinations thereof.

One or more embodiments include the process of any preceding paragraph, wherein the catalyst system further includes a support material including a magnesium halide.

One or more embodiments include the process of any preceding paragraph, wherein the catalyst system exhibits a molar ratio Mg:Ti of greater than 5:1.

One or more embodiments include the process of any preceding paragraph, wherein the catalyst system exhibits a molar ratio Mg:ID of less than 3:1.

One or more embodiments include the process of any preceding paragraph, wherein the olefin based polymer includes polyethylene.

One or more embodiments include the process of any preceding paragraph, wherein the ethylene based polymer exhibits a density (determined in accordance with ASTM D-792) of from 0.86 g/cc to 0.94 g/cc.

One or more embodiments include the process of any preceding paragraph, wherein the ethylene based polymer exhibits a melt index (MI₂) (determined in accordance with ASTM D-1238) in a range of 0.1 dg/min to 15 dg/min.

One or more embodiments include the process of any preceding paragraph, wherein the ethylene based polymer includes a linear low density polyethylene.

One or more embodiments include the process of any preceding paragraph, wherein the functionalized polyolefin includes a functional monomer selected from carboxylic acids and carboxylic acid derivatives, and acid and acid anhydride derivatives.

One or more embodiments include the process of any preceding paragraph, wherein the polyolefin based adhesive composition includes the functionalized polyolefin in a range of 0.5 wt. % to 30 wt. % based on the total weight of the polyolefin based adhesive composition.

One or more embodiments include an adhesive composition including a polyolefin based adhesive composition formed with a single heat cycle and including an olefin based polymer formed with catalyst system including a metal component generally represented by the formula:

MRₓ;

wherein M is a transition metal, R is a halogen, an alkoxy, or a hydrocarboxyl group and x is the valence of the transition metal, wherein the catalyst system further includes an internal donor including a C₃-C₆ cyclic ether; and supported on MgCl₂; and a functionalized polyolefin.

One or more embodiments include the adhesive composition of the preceding paragraph exhibiting a lower gel count than an identical composition formed via an off-line process.

One or more embodiments include the adhesive composition of any preceding paragraph, wherein the cyclic ethers are selected from tetrahydrofuran, dioxane, methyltetrahydrofuran and combinations thereof.

One or more embodiments include a multi-layer film including a plurality of resin layers; and one or more tie-layers disposed between at least two of the resin layers, wherein the tie layers are formed of the adhesive composition of any preceding paragraph.

While multiple embodiments are disclosed, still other embodiments will become apparent to those skilled in the art from the following detailed description. As will be apparent, certain embodiments, as disclosed herein, are capable of modifications in various obvious aspects, all without departing from the spirit and scope of the claims as presented herein. Accordingly, the drawings and detailed description are to be regarded as illustrative in nature and not restrictive.

### BRIEF DESCRIPTION OF DRAWINGS

The claimed subject matter may be understood by reference to the following description taken in conjunction with the accompanying drawings, in which like reference numerals identify like elements, and in which:

FIG. 1 illustrates an embodiment of an in-line process of forming an adhesive composition.

While the claimed subject matter is susceptible to various modifications and alternative forms, the drawings illustrate specific embodiments herein described in detail by way of example. It should be understood, however, that the description herein of specific embodiments is not intended to limit the claimed subject matter to the particular forms disclosed, but on the contrary, the intention is to cover all modifications, equivalents, and alternatives falling within the spirit and scope as defined by the appended claims.

### DETAILED DESCRIPTION OF THE INVENTION

Illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. Further, various ranges and/or numerical limitations may be expressly stated below. It should be recognized that unless stated otherwise, it is intended that endpoints are to be interchangeable. Further, any ranges include iterative ranges of similar magnitude falling within the expressly stated ranges or limitations disclosed herein is to be understood to set forth every number and range encompassed within the broader range of values. It is to be noted that the terms “range” and “ranging” as used herein generally refer to a value within a specified range and encompass all values within that entire specified range.

As used herein, the terms “up” and “down”, “upper” and “lower”, “upwardly” and “downwardly”, “upstream” and “downstream”, “above” and “below” and other like terms indicating relative positions above or below a given point or element are used in this description to more clearly describe some embodiments of the disclosure. However, when applied to equipment and methods for use in wells that are deviated or horizontal, such terms may refer to a left to right, right to left or other relationship as appropriate.

Furthermore, various modifications may be made within the scope of the disclosure as herein intended, and embodiments of the disclosure may include combinations of features other than those expressly claimed. In particular, flow arrangements other than those expressly described herein are within the scope of the disclosure.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of similar magnitude falling within the expressly stated ranges or limitations.

Polyolefin based adhesive compositions and methods of making and using the same are described herein. The polyolefin based adhesive compositions are generally formed of an olefin based polymer and a functionalized polyolefin.

Functionalized polyolefins are generally formed by grafting a functional monomer onto the backbone (i.e., main chain) of an olefin based polymer. It is recognized that the functional polyolefin includes an olefin based polymer and the subsequently formed adhesive composition includes an olefin based polymer. The olefin based polymers may be the same or different and are described in further detail below. However, in one or more embodiments, the olefin based polymer utilized to form the functional polyolefin may be different than the olefin based polymer utilized to form the adhesive composition. Thus, for clarity of the discussion herein, the olefin based polymer utilized to form the functional polyolefin may be referred to herein as a first olefin based polymer while the olefin based polymer of the adhesive composition (i.e., the polymer that is contacted with the functionalized polyolefin) may be referred to as a second olefin based polymer. However, such reference to “first” and “second” when referring to the olefin based polymer(s) is intended for purpose of clarity only and are not intended to be limiting for any other purpose.

The functional monomer may be grafted onto the first olefin based polymer via processes known to ones skilled in the art. For example, the graft may be formed via reactive extrusion processes. Reactive extrusion processes generally include contacting the olefin based polymer with the functional monomer within an extruder or in a solution process to form the functionalized polyolefin, for example.

The reactive extrusion processes may include any extrusion process known in the art. For example, raw materials (e.g., olefin based polymer and functional monomer) may be fed into a twin screw extruder in a concentration sufficient to form the functionalized polyolefin having a target graft content. The reaction to form the functionalized polyolefin may occur in the twin screw extruder under constant mixing and kneading, for example. Thus, the functionalized polyolefin generally includes a linear backbone of the first olefin based polymer with randomly distributed branches of the functional monomer, resulting in side chains that are structurally distinct from the main chain/backbone.

The functional monomer may include carboxylic acids and carboxylic acid derivatives, such as acrylic acid, maleic acid, fumaric acid, citraconic acid, mesaconic acid, maleic anhydride, 4-methyl cyclohex-4-ene-1,2-dicarboxylic acid or anhydride, bicyclo(2,2,2)oct-5-ene-2,3-dicarboxylic acid or anhydride, bicyclo(2,2,1)hept-5-ene-2,3-dicarboxylic acid or anhydride, tetrahydrophthalic acid or anhydride, methylbicyclo(2,2,1)hept-5-ene-2,3-dicarboxylic acid or anhydride, x-methylnorborn-5-ene-2,3 dicarboxylic acid and anhydride, norborn-5-ene-2,3, dicarboxylic acid and anhydride, maleo-pimaric acid, 1,2,3,4,5,8,9,10-octahydronaphthalene-2,3-dicarboxyic acid and anhydride, 2-oxa-1,3-diketospiro(4,4)non-7-ene, nadic anhydride and anhydride, methyl nadic anhydride, himic anhydride, methyl himic anhydride and combinations thereof, for example. Alternatively, the functional monomer may include acid and acid anhydride derivatives, such as dialkyl maleates, dialkyl fumarates, dialkyl itaconates, dialkyl mesaconates, dialkyl citraconates, alkyl crotonates and combinations thereof, for example.

The functionalized polyolefin may include the functional monomer in a range of 0.001 wt. % to 100 wt. %, or 0.01 wt. % to 15 wt. %, or 0.01 wt. % to 5 wt. %, or 0.1 wt. % to 3 wt. %, based on the total weight of the functionalized polyolefin, for example.

In one or more embodiments, the functionalized polyolefin may exhibit a grafting yield in a range of 0.2 wt. % to 20 wt. %, or 0.5 wt. % to 10 wt. % or 1 wt. % to 5 wt. %, for example. The grafting yield may be determined by Fourier Transform Infrared Spectroscopy (FTIR).

In one or more embodiments, the olefin based polymer contacts the functional monomer in the presence of an initiator. The initiator may include those known to ones skilled in the art, such as an organic peroxide, for example. However, as discussed previously herein, grafting can take place under high temperature and high shear and in absence of an initiator.

Prior processes (off-line systems) for forming polyolefin based adhesive compositions generally included extruding olefin based polymers (e.g., second olefin based polymers) upon withdrawal from a polymerization zone to form polyolefin pellets in a first extrusion process and then contacting those polyolefin pellets with the functionalized polyolefin in a second (or subsequent) extrusion process to form the polyolefin based adhesive composition.

Each extrusion process is generally referred to herein as a heat cycle. A heat cycle generally refers to heating a respective polymer to a temperature sufficient to at least partially melt the polymer and form a molten polymer and then cooling the molten polymer to a temperature sufficient to at least partially solidify the molten polymer.

In contrast, in the embodiments described herein, the second olefin based polymer undergoes a single heat cycle in the formation of the polyolefin based adhesive composition. For example, in one or more embodiments, the olefin based polymer recovered from a polymerization zone (e.g., the second olefin based polymer) is directly contacted with the functionalized polyolefin to form the polyolefin based adhesive composition. For example, the second olefin based polymer may be withdrawn from the polymerization zone and melt blended with the functionalized polyolefin to form the polyolefin based adhesive composition. Such melt blending may occur via extrusion, for example. In such embodiments, it is to be noted that while the second olefin based polymer contacts the functionalized polyolefin during the melt blending, the initial contact of the second olefin based polymer and the functionalized polyolefin may occur prior to melt blending, such as in a mixer, a feeder or a storage vessel, for example.

As used herein, the term “directly” refers to withdrawing the olefin based polymer (e.g., second olefin based polymer) from the polymerization zone and contacting the olefin based polymer with the functionalized polyolefin without an intervening heat cycle. In such embodiments, the second olefin based polymer contacts the functionalized polyolefin prior to pelletization of the second olefin based polymer and thus, the second olefin based polymer undergoes a single heat cycle in the formation of the polyolefin based adhesive composition.

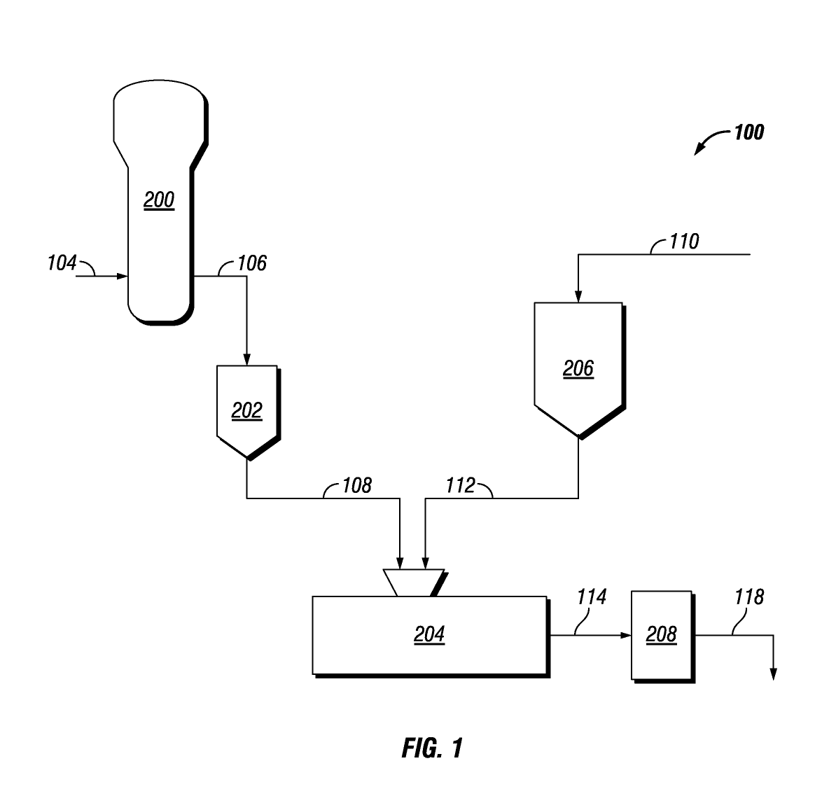

An illustrative schematic of such an embodiment is illustrated in FIG. 1. FIG. 1 illustrates in-line process 100 for forming an adhesive composition. Within the process 100, olefin monomer (not shown) and optionally co-monomer (not shown) is introduced into a polymerization zone (or reactor) 200 via a reactor feed line 104. The olefin monomer contacts a polymerization catalyst system (not shown) disposed within the polymerization zone 200 under polymerization conditions sufficient to form an olefin based polymer (not shown). The olefin based polymer (not shown) is withdrawn or recovered from the polymerization zone 200 via reactor exit line 106 and passes through an optional powder silo (vessel or bin) 202 to an extruder 204 via first an extruder-feed line 108. A functionalized polyolefin (not shown) is introduced into an optional graft silo (vessel or bin) 206 via graft-feed line 110. The functionalized polyolefin (not shown) is fed to the extruder 204 via a second extruder-feed line 112. The functionalized polyolefin (not shown) and the olefin based polymer (not shown) are mixed in the extruder 204 (optionally under shear mixing sufficient to blend the components and any additives). The mixed functionalized polyolefin and olefin based polymer form the polyolefin based adhesive composition (not shown) within the extruder 204. The adhesive composition (not shown) is fed (optionally by an un-shown melt pump) from the extruder 204 to a pelletizer 208 via a pelletizer feed line 114. The adhesive composition (not shown) is pelletized in the pelletizer 208 and recovered as product via product line 118. Optionally, the pelletized adhesive composition may be accumulated in bins (not shown) and shipped to customers. Additional equipment components, such as feeders, additive bins, degassers, screen packs, and storage tanks are contemplated for use but are known to ones skilled in the art and thus not shown in FIG. 1.

In an embodiment, the processes described herein are in-line processes to form adhesive resins (also called adhesive compositions). In an embodiment, an in-line process is a process in which an adhesive resin is formed using a polyolefin from a reactor (also called the second olefin based polymer) that undergoes a single heat cycle (or a single heat history, or a single pelletization step). In an embodiment, the in-line process includes withdrawing (by pump, pressure, fluid flow, or gravity) polyolefin powder off of a reactor and melt mixing it (optionally in an extruder)—without prior pelletization of the polyolefin powder—with an adhesive graft (also called a functionalized polyolefin) to form an adhesive resin, which is then pelletized.

The adhesive graft (also called a functionalized polyolefin) may be pelletized separately from (and optionally prior to) the in-line process. In other words, the single heat history of the in-line process refers to the melt history of the second olefin based polymer and does not include the formation (or melt history) of the adhesive graft (also called a functionalized polyolefin).

In embodiments of in-line processes, virgin polyolefin powder may be melt mixed with the adhesive graft; and optionally, additives are introduced to the polyolefin powder before it is melt mixed with the adhesive graft. In embodiments of in-line processes, the virgin polyolefin (or polyolefin stabilized with additives) may undergo cooling as it is transported from the reactor to the melt mixer; alternatively the cooling is minimized (by, for example, insulating the pipes, or using a relatively short distance of pipe—as is practical within a commercial chemical plant). In alternative embodiments of in-line processes, the virgin polyolefin (or polyolefin stabilized with additives) is stored in a vessel (such as a silo) before it is melt mixed with the adhesive graft. In this alternative embodiment, the virgin polyolefin (or polyolefin stabilized with additives) is allowed to cool more significantly and optionally to ambient or near ambient temperature.

In an alternative embodiment, an in-line process is a closed, continuous, and/or connected process for melt mixing polyolefin powder with an adhesive graft to form an adhesive resin. In one or more embodiments, a closed system is one with minor exposure to oxygen. It is to be noted that closed systems may inevitably include the exposure to oxygen either through the external introduction of oxygen and/or oxygen containing compounds to the system, leaks in pipes, via in-situ generation of oxygen containing compounds within the system, or via minor amounts of oxygen that may be introduced to the reactor (for example oxygen may be used as a catalyst terminator in the reactor) and carried through to the melt mixer (also called extruder). However, such oxygen levels are at “minor” levels such that detrimental effect/degradation is not observed in the second olefin based polymer. In one or more embodiments, a connected system is one in which the second olefin based polymer is manufactured and extruded on-site without the need for being moved (for example by truck or rail) to another compounding facility (for example, a toll compounder or a compounding facility located onsite). In an embodiment, continuous and connected systems are those in which the polyolefin is carried (optionally directly) from the reactor to the melt mixer without an intermediate transportation step (by for example rail or truck) to a separate facility. In an embodiment, continuous and connected systems may include some intermittent storage of the polyolefin in a vessel or silo.

The in-line system is in contrast to an “off-line” system, wherein in one or more embodiments, the second olefin based polymer is produced and pelletized on one plant site. The pelletized polyolefin is then moved (optionally by truck or rail) to a second location for compounding with a functionalized composition. The second location can be a new toll compounder (i.e., a new company) or can be a separate part of a single plant site. Thus, an in-line system may utilize a single extruder whereas an off-line system utilizes multiple extruders. As mentioned above and in various embodiments, in both the in-line and off-line processes the functionalized polyolefin is pelletized separately (optionally in a prior system).

The in-line processes of the embodiments herein result in polyolefin based adhesive compositions exhibiting improved properties, such as reduced yellowness and/or gels in comparison to off-line systems. Visually, yellowness is associated with product degradation by light, chemical exposure and processing. The yellowness index is calculated by the Hunter colorimeter per ASTM method E-313.

The polyolefin based adhesive composition may include the functionalized polyolefin in a range of 0.5 wt. % to 30 wt. %, or 1 wt. % to 20 wt. %, or 2 wt. % to 15 wt. %, or 5 wt. % to 15 wt. %, or 6 wt. % to 11 wt. %, or 12 wt. % to 17 wt. %, based on the total weight of the polyolefin based adhesive composition, for example.

In one or more embodiments, the polyolefin based adhesive composition may contain additives to impart desired physical properties, such as printability, increased gloss, or a reduced blocking tendency. Examples of additives may include, without limitation, stabilizers, ultraviolet screening agents, oxidants, anti-oxidants, anti-static agents, ultraviolet light absorbents, fire retardants, processing oils, mold release agents, coloring agents, pigments/dyes, fillers or combinations thereof, for example. These additives may be included in amounts effective to impart desired properties.

It is further contemplated that the additives may include one or more adhesion-promoting resins, such as thermoplastic elastomers.

In one or more embodiments, the additives are melt blended with the second olefin based polymer and the functionalized polyolefin. Such melt blending may occur when the second olefin based polymer is melt blended with the functionalized polyolefin, for example.

Catalyst systems useful for polymerizing olefin monomers include any suitable catalyst system. For example, the catalyst system may include chromium based catalyst systems, single site transition metal catalyst systems including metallocene catalyst systems, Ziegler-Natta catalyst systems or combinations thereof, for example. The catalysts may be activated for subsequent polymerization and may or may not be associated with a support material, for example. A brief discussion of such catalyst systems is included below, but is in no way intended to limit the scope of the disclosure to such catalysts.

Catalyst systems useful for polymerizing olefin monomers may include Ziegler-Natta catalyst systems, for example. Ziegler-Natta catalyst systems are generally formed from the combination of a metal component (e.g., a potentially active catalyst site) with one or more additional components, such as a catalyst support, a co-catalyst and/or one or more electron donors, for example.

A specific example of a Ziegler-Natta catalyst includes a metal component generally represented by the formula:

MRₓ;

wherein M is a transition metal, R is a halogen, an alkoxy, or a hydrocarboxyl group and x is the valence of the transition metal. For example, x may be from 1 to 4.

The transition metal may be selected from Groups IV through VIB (e.g., titanium, chromium or vanadium), for example. R may be selected from chlorine, bromine, carbonate, ester, or an alkoxy group in one embodiment. Examples of catalyst components include TiCl₄, TiBr₄, Ti(OC₂H₅)₃Cl, Ti(OC₃H₇)₂Cl₂, Ti(OC₆H₁₃)₂Cl₂, Ti(OC₂H₅)₂Br₂ and Ti(OC₁₂H₂₅)Cl₃, for example.

Those skilled in the art will recognize that a catalyst may be “activated” in some way before it is useful for promoting polymerization. As discussed further below, activation may be accomplished by contacting the catalyst with an activator, which is also referred to in some instances as a “co-catalyst”. Embodiments of such Z—N activators include organoaluminum compounds, such as trimethyl aluminum (TMA), triethyl aluminum (TEAl) and triisobutyl aluminum (TiBAl), for example.

The Ziegler-Natta catalyst system may further include one or more electron donors, such as internal electron donors and/or external electron donors. The internal electron donors may include amines, amides, esters, ketones, nitriles, ethers, thioethers, thioesters, aldehydes, alcoholates, salts, organic acids, phosphines, diethers, succinates, phthalates, malonates, maleic acid derivatives, dialkoxybenzenes or combinations thereof, for example.

In one or more embodiments, the internal donor includes a C₃-C₆ cyclic ether, or a C₃-C₅ cyclic ether. For example, the cyclic ethers may be selected from tetrahydrofuran, dioxane, methyltetrahydrofuran and combinations thereof. (See, WO2012/025379, which is incorporated by reference herein.)

The external electron donors may include monofunctional or polyfunctional carboxylic acids, carboxylic anhydrides, carboxylic esters, ketones, ethers, alcohols, lactones, organophosphorus compounds and/or organosilicon compounds. In one embodiment, the external donor may include diphenyldimethoxysilane (DPMS), cyclohexylmethyldimethoxysilane (CMDS), diisopropyldimethoxysilane (DIDS) and/or dicyclopentyldimethoxysilane (CPDS), for example. The external donor may be the same or different from the internal electron donor used. However, in one or more embodiments, the catalyst system is absent external donor.

The components of the Ziegler-Natta catalyst system (e.g., catalyst, activator and/or electron donors) may or may not be associated with a support, either in combination with each other or separate from one another. In one or more embodiments, the Z—N support materials may include a magnesium dihalide, such as magnesium dichloride or magnesium dibromide or silica, for example.

In one or more embodiments, the support may include a magnesium compound represented by the general formula:

MgCl₂(R″OH)ₘ;

wherein R″ is a C₁-C₁₀ alkyl and m is in a range of 0.5 to 3.

In one or more embodiments, the Ziegler-Natta catalyst system exhibits a molar ratio of support to metal component (measured as the amount of metal of each component) Mg:Ti of greater than 5:1, or in a range of 7:1 to 50:1, or 10:1 to 25:1, for example.

In one or more embodiments, the Ziegler-Natta catalyst system exhibits a molar ratio of support to internal donor Mg:ID of less than 3:1, or less than 2.9:1, or less than 2.6:1, or less than 2.1:1, or less than 2:1, or from 1.1:1 to 1.4:1, for example.

In one or more embodiments, the Ziegler-Natta catalyst system exhibits an X-ray diffraction spectrum in which the range of 2Θ diffraction angles between 5.0° and 20.0°, at least three main diffraction peaks are present at diffraction angles 2Θ of 7.2±0.2°, and 11.5±0.2° and 14.5±0.2°, the peak at 2Θ of 7.2±0.2° being the most intense peak and the peak at 11.5±0.2° having an intensity less than 0.9 times the intensity of the most intense peak.

In one or more embodiments, the intensity of the peak at 11.5° has an intensity less than 0.8 times the intensity of the diffraction peak at 2Θ diffraction angles of 7.2±0.2°. In one or more embodiments, the intensity of the peak at 14.5±0.2° is less than 0.5 times, or less than 0.4 times the intensity of the diffraction peak at 2Θ diffraction angles of 7.2±0.2°.

In one or more embodiments, another diffraction peak is present at diffraction angles 2Θ of 8.2±0.2° having an intensity equal to or lower than the intensity of the diffraction peak at 2Θ diffraction angles of 7.2±0.2°. For example, the intensity of the peak at diffraction angles 2Θ of 8.2±0.2° is less than 0.9, or less than 0.5 times the intensity of the diffraction peak at 2Θ diffraction angles of 7.2±0.2°.

In one or more embodiments, an additional broad peak is observed at diffraction angles 2Θ of 18.2±0.2° having an intensity less than 0.5 times the intensity of the diffraction peak at 2Θ diffraction angles of 7.2±0.2°. As referenced herein, the X-ray diffraction spectra are collected by using Bruker D8 advance powder diffractometer.

The Ziegler-Natta catalyst may be formed by any method known to one skilled in the art. For example, the Ziegler-Natta catalyst may be formed by contacting a transition metal halide with a metal alkyl or metal hydride. (See, U.S. Pat. No. 4,298,718, U.S. Pat. No. 4,298,718, U.S. Pat. No. 4,544,717, U.S. Pat. No. 4,767,735, and U.S. Pat. No. 4,544,717, which are incorporated by reference herein.)

Olefin based polymers formed by catalyst systems having the specific internal donors discussed herein have been found to exhibit low levels of xylene solubles. Xylene solubles refers to the portion of a polymer that is soluble in xylene and that portion is thus termed the xylene soluble fraction (XS %). In determining XS %, the polymer is dissolved in boiling xylene and then the solution is cooled to 0° C. The XS % is that portion of the dissolved polymer that remains soluble in the cold xylene.

In one or more embodiments, the second olefin based polymer exhibits a xylene soluble fraction (determined in accordance with ASTM D-5492-98) of less than 1.5%, or less than 1.0%, or less than 0.5%, for example.

Gels can originate from a number of sources, including crosslinking reactions during polymerization, insufficient mixing, homogenization during melt blending and homogenization and crosslinking during film extrusion, for example. Gels are generally undesirable as they can negatively affect subsequent film performance and appearance. For example, high concentrations of gels may cause the film to break in the film production line or during subsequent stretching. As used herein, “gels” are defined as particles having a size greater than 200 μm.

In one or more embodiments, the second olefin based polymer exhibits a gel defect area of 25 ppm or less, or 20 ppm or less, for example. As used herein “gel defect area” refers to the measurement of gels in films and is measured via commercially available gel measurement systems commercially available by OCS GmbH, the Optical Control Systems film scanning system FS-5.

As indicated elsewhere herein, the catalyst systems are used to form olefin based polymer compositions (which may be interchangeably referred to herein as polyolefins). Once the catalyst system is prepared, as described above and/or as known to one skilled in the art, a variety of processes may be carried out using that composition to form olefin based polymers. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example.

In certain embodiments, the processes described above generally include polymerizing one or more olefin monomers to form olefin based polymers. The olefin monomers may include C₂ to C₃₀ olefin monomers, or C₂ to C₁₂ olefin monomers (e.g., ethylene, propylene, butene, pentene, 4-methyl-1-pentene, hexene, octene and decene), for example. It is further contemplated that the monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, norbornadiene, isobutylene, isoprene, vinylbenzlycyclobutane, styrene, alkyl substituted styrene, ethylidene norbornene, dicyclopentadiene and cyclopentene, for example. The formed polymer may include homopolymers, copolymers or terpolymers, for example.

The olefin based polymers may include, but are not limited to, linear low density polyethylene, elastomers, plastomers, high density polyethylenes, low density polyethylenes, medium density polyethylenes, polypropylene and polypropylene copolymers, for example.

Unless otherwise designated herein, all testing methods are the current methods at the time of filing. In one or more embodiments, the olefin based polymers include ethylene based polymers. As used herein, the term “ethylene based” is used interchangeably with the terms “ethylene polymer” or “polyethylene” and refers to a polymer having at least 50 wt. %, or at least 70 wt. %, or at least 75 wt. %, or at least 80 wt. %, or at least 85 wt. % or at least 90 wt. % polyethylene relative to the total weight of polymer, for example.

The ethylene based polymers may include one or more co-monomers, such as those discussed previously herein. For example, the ethylene based polymers may include one or more co-monomers selected from propylene, 1-butene, 1-hexene, 1-octene and combinations thereof. In one or more embodiments, the ethylene based polymer includes one or more co-monomers selected from 1-butene, 1-hexene and combinations thereof. The ethylene based polymer may include co-monomer in a range of 5 wt. % to 10 wt. % based on the total weight of the olefin based polymer, for example.

The ethylene based polymers may have a density (determined in accordance with ASTM D-792) of from 0.86 g/cc to 0.94 g/cc, or from 0.91 g/cc to 0.94 g/cc, or from 0.915 g/cc to 0.935 g/cc, for example.

The ethylene based polymers may have a melt index (MI₂) (determined in accordance with ASTM D-1238) of from 0.1 dg/min to 15 dg/min, from 0.1 dg/min to 10 dg/min, or from 0.05 dg/min to 8 dg/min, for example.

In one or more embodiments, the first olefin based polymers include high density polyethylene. As used herein, the term “high density polyethylene” refers to ethylene based polymers having a density of from about 0.94 g/cc to about 0.97 g/cc, for example.

In one or more embodiments, the second olefin based polymers include low density polyethylene. As used herein, the term “low density polyethylene” refers to ethylene based polymers having a density in a range of 0.88 g/cc to 0.925 g/cc, for example.

In one or more embodiments, the second olefin based polymers include linear low density polyethylene. As used herein, the term “linear low density polyethylene” refers to substantially linear low density polyethylene characterized by the absence of long chain branching.

In one or more embodiments, the olefin based polymers include medium density polyethylene. As used herein, the term “medium density polyethylene” refers to ethylene based polymers having a density of from 0.92 g/cc to 0.94 g/cc or from 0.926 g/cc to 0.94 g/cc, for example.

The polyolefin based adhesive compositions are useful in applications known to one skilled in the art to be useful for conventional polymeric compositions, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact applications. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheets, such as thermoformed sheets (including profiles and plastic corrugated cardboard), geomembranes and pond liners, for example. Molded articles include single and multi-layered constructions in the form of bottles, tanks, large hollow articles, rigid food containers and toys, for example.

The homogeneous distribution of co-monomer in and among the polymer chains is important for subsequent film production. Thus, the second polyolefin composition generally exhibits a substantially homogeneous co-monomer distribution.

The polyolefin based adhesive composition can be utilized in the production of composite structures, e.g., multi-layer films, wherein a layer of the polyolefin based adhesive composition is applied to one or more layers of the multi-layer film by methods known in the art, such as co-extrusion, for example. The multi-layer films may include one or more layers formed from nylon, polyolefins, polar substrates such as ethylene vinyl alcohol (EVOH) and polyamides with one or more styrene polymers, including styrene homopolymers, copolymers, and impact modified polystyrenes, for example. The polyolefin based adhesive compositions may be utilized as tie-layers in the multi-layer films. Tie layers are generally utilized as a layer disposed between two additional layers to improve the adhesion therebetween.

Tie-layers in the composite structures may experience significant stresses which are created at an interface between the tie-layer and the layer to which the tie-layer is adhered. However, the tie-layer adhesives of the embodiments described herein exhibit substantial and unexpected adhesive properties even under such significant stresses.

The multi-layer film may include any number of layers sufficient to satisfy its application. For example, the multi-layer film may include at least 2, or 3, or 4, or 5 or 6, or 7, or 9, or 11 layers, for example.

The polyolefin based adhesive compositions exhibit excellent adhesion under a variety of conditions to non-polar polyolefins, polar polymers and styrenic substrates, for example.

### Examples

To facilitate a better understanding of the disclosure, the following examples of embodiments are given. In no way should the following examples be read to limit, or to define, the scope of the appended claims.

Various adhesive compositions were evaluated for use as tie-layers in multi-layer films. Resin A included about 91.5 wt. % ethylene butene LLDPE and about 8.5 wt. % functionalized polyolefin and exhibited a density of about 0.922 g/cm³. Resin B generally included about 86 wt. % ethylene/butene LLDPE and about 14 wt. % functionalized polyolefin and exhibited a density of about 0.924 g/cm³. The LLDPE of both Resin A and B was prepared with the Ziegler-Natta catalysts described herein.

The functionalized polyolefin was a high density polyethylene grafted with maleic anhydride. The functionalized polyolefin utilized in Resin A had a maleic anhydride content of 1.6 wt. % while the functionalized polyolefin utilized in Resin B had a maleic anhydride content of 1.9 wt. %.

The in-line samples were prepared via a single heat cycle by discharging a polyolefin from a polymerization reactor in the form of a powder and feeding the polyolefin into an accumulator bin in line with the reactor. The functionalized polyolefin was introduced into a second accumulator bin and then both components were fed together into a mixer where they were mixed and heated to a temperature of about 400-450° F., subjected to shear mixing and pelletized. The off-line samples were prepared via multiple heat cycles (e.g., previously manufactured and pelletized resin mixed with functionalized polyolefin in a twin screw extruder heated to a temperature of about 400-450° F., subjected to shear mixing and pelletized).

To determine the gel counts and distribution of gels in the various adhesive compositions, samples of each adhesive composition were separately introduced into a single screw extruder and extruded into 2 mil monolayer cast films. The content of gelled polymer in the resulting films was determined by counting the number of gels in a given area (10 m²) and normalizing the count by a laser gel scanner (i.e., film inspection methods commercially available through OCS Optical Control Systems GmbH). The results are illustrated in TABLE 1 below:

TABLE 1

| | | | Total | % Defects | | | | | | | | | | | % Gels |
|---|---|---|---|---|---|---|---|---|---|---|---|---|---|---|---|
| | Production | | defects | compared to | # of Defects of specified average size (microns) | | | | | | | | | | Compared to |
| Run # | Type | Resin | (ppm) | Off-line | 200 | 300 | 500 | 800 | 1500 | 1600 | 1750 | 2000 | >2000 | Total | Off-Line |
| 1 | In-Line | A | 73.4 | 31.3 | 1071 | 759 | 119 | 8.1 | 0.8 | 0.0 | 0.0 | 0.0 | 0.0 | 19584 | 47.2 |
| 2 | In-Line | A | 124.7 | 53.2 | 1099 | 787 | 143 | 10.7 | 1.9 | 0.0 | 0.0 | 0.0 | 0.0 | 20445 | 49.2 |
| 3 | In-Line | A | 69.7 | 29.7 | 1022 | 723 | 116 | 6.3 | 0.6 | 0.0 | 0.0 | 0.0 | 0.0 | 18659 | 44.9 |
| 4 | Off-Line | A | 234.4 | 100 | 1854 | 1685 | 557 | 48.2 | 4.3 | 0.2 | 0.1 | 0.0 | 1.0 | 41514 | 100.0 |
| 5 | In-Line | B | 73.6 | 12.3 | 1026 | 733 | 131 | 10.8 | 1.1 | 0.0 | 0.0 | 0.0 | 0.0 | 19036 | 19.1 |
| 6 | In-Line | B | 88.7 | 14.9 | 1270 | 916 | 148 | 8.1 | 2.0 | 0.0 | 0.0 | 0.0 | 0.0 | 23447 | 23.5 |
| 7 | In-Line | B | 67.9 | 11.4 | 1030 | 674 | 115 | 6.4 | 0.9 | 0.0 | 0.0 | 0.0 | 0.0 | 18264 | 18.3 |
| 8 | In-Line | B | 77.6 | 13.0 | 1195 | 782 | 129 | 5.9 | 1.2 | 0.0 | 0.0 | 0.0 | 0.0 | 21133 | 21.2 |
| 9 | Off-Line | B | 596.0 | 100.0 | 3775 | 3990 | 1901 | 277 | 35.6 | 1.0 | 1.1 | 0.6 | 0.5 | 99850 | 100.0 |

It was observed that the adhesive compositions prepared by the embodiments described herein, exhibited gel counts substantially lower than that of the adhesive compositions prepared via off-line methods.

The yellowness index of various in-line samples was further measured via ASTM method E-313 and is reported in TABLE 2 below:

TABLE 2

| Identification # | Resin | YI |
|---|---|---|
| 2603 | A | 3.54 |
| 2710 | A | 5.15 |
| 2807 | A | 5.46 |
| 2709 | A | 5.43 |
| 2801 | A | 5.51 |
| 2802 | A | 5.4 |
| 2803 | A | 5.13 |
| 2805 | B | 8.13 |
| 2807 | B | 8.3 |
| 2809 | B | 7.78 |
| 2811 | B | 8.12 |

To evaluate adhesion of the tie-layer compositions, 3 and 5 mil multi-layer films were prepared by co-extrusion. The five layer coextruded films had an A/B/C/B/A layer structure where B represents the tie layer composition, C represents EVOH and A represents high density polyethylene (HDPE) layers. The films were produced on a Killion laboratory scale film line using three 1 inch extruders in an A/B/C/B/A feedblock configuration. Films were extruded using a 10 inch flat die to produce continuous 8 inch wide samples.

Adhesion values reported herein were determined in accordance with ASTM D 1876-9. The tie-layer was formed with Resin A via the in-line method and the adhesive composition was co-extruded with HDPE and EVOH resins to produce a multi-layer co-extruded film having 43% HDPE/4% tie-layer/6% EVOH/4% tie-layer/43% HDPE. The EVOH used was a commercial resin obtained from Nippon Ghsei including 32 mol % ethylene while the polyethylene was a 1 MI HDPE produced by Equistar Chemicals. Temperatures in the three heating zones and at the die for each of the three extruders used to co-extrude the 5 layer sheet were as follows:

| | |
|---|---|
| HDPE | 360° F./390° F./400° F./425° F. |
| EVOH | 350° F./380° F./400° F./435° F. |
| Tie-Layer | 380° F./380° F./390° F./410° F. |

Excellent adhesion of the in-line tie-layer-A to the EVOH copolymer layer was observed. The results are illustrated in TABLE 3 below.

TABLE 3
(Adhesion of In-line Tie-layer A to EVOH)

| | | Run number | | | |
|---|---|---|---|---|---|
| | | 1 | 2 | 3 | 4 |
| Layer thickness (mil) | Days | Adhesion (lb/in) | | | |
| 3 | 1 | 0.75 | 0.78 | 0.76 | 0.74 |
| 3 | 4 | 0.85 | 0.91 | 0.83 | 0.82 |
| 5 | 1 | 0.96 | 0.87 | 1.05 | 0.98 |
| 5 | 4 | 1.33 | 1.13 | 1.31 | 1.22 |

While the foregoing is directed to embodiments of the present disclosure, other and further embodiments of the disclosure may be devised without departing from the basic scope thereof and the scope thereof is determined by the claims that follow.

What is claimed is:

1. A process of forming an adhesive composition comprising:
contacting an olefin monomer with a catalyst system within a polymerization zone to form an olefin based polymer under polymerization conditions sufficient to form the olefin based polymer, the catalyst system comprising a metal component generally represented by the formula:
MRₓ;
wherein M is a transition metal, R is a halogen, an alkoxy, or a hydrocarboxyl group and x is the valence of the transition metal, wherein the catalyst system further comprises an internal donor (ID) comprising a C₃-C₆ cyclic ether; and
withdrawing the olefin based polymer from the polymerization zone; and
melt blending the olefin based polymer with a functionalized polyolefin to form a polyolefin based adhesive composition,
wherein the process is an in-line process.

2. The process of claim 1, wherein the olefin based polymer contacts the functionalized polyolefin prior to pelletization.

3. The process of claim 1 further comprising melt blending the olefin based polymer and the functionalized polyolefin in the presence of an adhesion promoting additive.

4. The process of claim 1, wherein the transition metal is selected from titanium, chromium and vanadium.

5. The process of claim 1, wherein the metal component is selected from TiCl₄, TiBr₄, Ti(OC₂H₅)₃Cl, Ti(OC₃H₇)₂Cl₂, Ti(OC₆H₁₃)₂Cl₂, Ti(OC₂H₅)₂Br₂ and Ti(OC₁₂H₂₅)Cl₃.

6. The process of claim 1, wherein the catalyst system further comprises an organoaluminum compound selected from trimethyl aluminum (TMA), triethyl aluminum (TEAl) and triisobutyl aluminum (TiBAl).

7. The process of claim 1, wherein the cyclic ethers are selected from tetrahydrofuran, dioxane, methyltetrahydrofuran and combinations thereof.

8. The process of claim 1, wherein the catalyst system further comprises a support material comprising a magnesium halide.

9. The process of claim 8, wherein the catalyst system exhibits a molar ratio Mg:Ti of greater than 5:1.

10. The process of claim 8, wherein the catalyst system exhibits a molar ratio Mg:ID of less than 3:1.

11. The process of claim 1, wherein the olefin based polymer comprises polyethylene.

12. The process of claim 11, wherein the olefin based polymer exhibits a density (determined in accordance with ASTM D-792) of from 0.86 g/cc to 0.94 g/cc.

13. The process of claim 11, wherein the olefin based polymer exhibits a melt index (MI₂) (determined in accordance with ASTM D-1238) in a range of 0.1 dg/min to 15 dg/min.

14. The process of claim 11, wherein the olefin based polymer comprises an ethylene/butene linear low density copolymer.

15. The process of claim 1, wherein the functionalized polyolefin comprises a functional monomer selected from carboxylic acids and carboxylic acid derivatives, and acid and acid anhydride derivatives.

16. The process of claim 1, wherein the polyolefin based adhesive composition comprises the functionalized polyolefin in a range of 0.5 wt. % to 30 wt. %, based on the total weight of the polyolefin based adhesive composition.

17. An adhesive composition comprising:
a polyolefin based adhesive composition formed with a single heat cycle and comprising:
an olefin based copolymer of ethylene and butene formed with catalyst system comprising a metal component generally represented by the formula:
MRₓ;
wherein M is a transition metal, R is a halogen, an alkoxy, or a hydrocarboxyl group and x is the valence of the transition metal, wherein the catalyst system further comprises an internal donor comprising a C₃-C₆ cyclic ether; and supported on MgCl₂; and
a functionalized polyolefin.

18. The adhesive composition of claim 17, exhibiting a lower gel count than an identical composition formed via an off-line process.

19. The process of claim 1, wherein the cyclic ethers are selected from tetrahydrofurane, dioxane, methyltetrahydrofurane and combinations thereof.

20. A multi-layer film comprising:
a plurality of resin layers; and
one or more tie-layers disposed between at least two of the resin layers, wherein the tie layers are formed of the adhesive composition of claim 17.
